(19) United States
(12) Patent Application Publication
(10) Pub. No.: US 2008/0172461 A1
(43) Pub. Date: Jul. 17, 2008

(54) Contextual persona management in a communication medium to enhance relationship based interaction

(75) Inventors: Balaji T. Thattai, Sunnyvale, CA (US); S. Srinivasan, Cupertino, CA (US)

Correspondence Address: Raj Abhyanker, LLP;c/o Intellevate, P.O. Box 52050, Minneapolis, MN, 55402, US

(73) Assignee: NthID Networks, Inc.

(21) Appl. No.: 11/653,164

(22) Filed: Jan. 12, 2007

(51) Int. Cl. G06F 15/16

(52) U.S. Cl. 709/204

(57) ABSTRACT

A method, system and apparatus of contextual persona management in a communication medium to enhanced relationship based interaction are disclosed. In one embodiment, a method of a communication system includes creating a persona profile having contacts of a user in a specific context of expression generating in the persona profile, representations of contacts and interest groups between the user and the contacts shifting a pane between the persona profile and other persona profiles while maintaining a relationship between the user and a particular contact which is independent of the persona profile and the other persona profiles. In addition, the method may include juggling between different contracts in each of the persona profiles based on at least one of a behavior of the user. The method may also include providing the feedback ratings through intelligence gathered from personal representation of the user to other users.

### FIELD OF TECHNOLOGY

This disclosure relates generally to the technical fields of communications and, in one example embodiment, to a method, system and apparatus of contextual persona management in a communication medium to enhance relationship based interaction.

### BACKGROUND

A user (e.g., a person) may communicate differently with different groups of people. For example, the user may communicate with his/her friends using an informal tone of expression (e.g., playful, unabashed, free-flowing, etc.). In contrast, the user may communicate with his/her co-workers using a formal tone of expression (e.g., deliberated, careful, focused, etc.). These different communication styles may each reflect a persona of the user. The persona may be a social role played by the user when interacting in a specific context (e.g., may change according to situation, time, and/or context).

The user may communicate with the different groups of people through a variety of mechanisms (e.g., email, instant messaging, simple text messaging, voice, non-verbal expressions, etc.). Each mechanism may have a particular form in which communication occurs. For example, the user may communicate with his/her co-workers through a corporate email system (e.g., Microsoft® Outlook). In contrast, the user may communicate with friends through a public free email provider (e.g., Google® Gmail), through a telephone (e.g., text messaging system and/or voice system) and/or through a social network (e.g., MySpace®, Friendster®, etc.).

A multitude of social roles of the user may result in role confusion. Role confusion may be a situation where the user has trouble determining which role he/she should play. For example, the user may be a college student who joins a group of a social interest (e.g., a Football group) in the social network and finds a professor as also being a member of the group. A conflict may emerge between the user's behavior as a student and as an enthusiast (e.g., who shares a same interest as the professor) leading to confusion. The user may communicate with the professor through email in a formal, deferential tone when discussing college homework, but in an informal tone when discussing sports in the social network.

As such, the social role may be a set of expectations that society places on the user. By unspoken consensus, certain behaviors may be deemed “appropriate” and others “inappropriate”. The social role may be what the college student does (or, at least, is expected to do), while status may be what the college student is. In other words, “status” may be a state the user occupies, while “role” may be an expected behavior attached to that position by the user. The social role may not be limited to occupational status, nor may the fact that one is cast in the social role of the “college student” during daylight hours prevent one from taking other private (e.g., invisible, alter-ego limited to self), semi-private (e.g., limited visibility to selected few), and/or public (e.g., visible to all) social roles at other times (e.g., spouse, golf club president, aerobics instructor, swinger, clubgoer, fraternity brother, friend, philanthropist, etc).

The social role can be semi-permanent (e.g., “male”, “mother”, “child”, etc), or it may be transitory (e.g., “soccer player”, “political enthusiast”, “college student”, etc). When communication modalities become complex, it may become increasingly difficult for the user to draw associations of context when communicating with specific others. For example, the user may forget that a particular person, 5 years earlier, was known to the user during his/her college days as a classmate acquaintance. A loss of this context in relationships of the user, across time, may result in a loss of relationships and/or diminished social interactions as time progresses. In addition, role confusion may increase stress on the user and/or may sometimes result in embarrassing complexity in misguided communications of the user with other parties.

### SUMMARY

A method, system and apparatus of contextual persona management in a communication medium to enhance relationships based interaction are disclosed. In one aspect, a method of a communication system includes creating a persona profile having contacts of a user in a specific context of expression, generating in the persona profile, representations of contacts and interest groups between the user and the contacts, and shifting a pane between the persona profile and other persona profiles while maintaining relationships between the user and a particular contact which is independent of the persona profile and the other persona profiles.

The method may include juggling between different contacts in each of the persona profiles based on a behavior of the user and/or a feedback rating provided of the user by other parties. In addition, the method may include providing the feedback ratings through intelligence gathered from personal representation of the user to other users, perception of other users, a behavior analysis of the user and/or linked other users through a relationships behavior compounding algorithm, and/or collective contact rating of peers.

The method may further include enabling facets through the feedback ratings that are created through implicit and/or explicit techniques based on trust, affinity, and/or propensity of interaction and in which multiple facets coexist in each persona profile and/or which may develop a set of rankings of the user with other users through each of the facets.

The method may also include applying a temporal aspect to each of the facets based on the propensity that may be user determined and/or automatically determined through a usage pattern mapping of the user with facets associated with the user to enable a time based priority ranking of the particular contact with other contacts.

Also, the method may include automatically assigning a set of overridable specialized facets based on the behavior of the user including a family facet having a family relationships constructor, a work facet having an organization chart constructor, and/or a social facet having an activity classifier to enable the user to manifest specialized facets in context of a particular scenario of communications.

The method may include generating a life map of the user in which differing activities and/or behaviors of the user are simultaneously expressed in an electronic environment. Furthermore, the method may include organizing the life map around one common marker which may be selected between people communications, events, groups, places, messages, money, and/or content including music, books, and/or news feeds.

The method may also include expressing a faceted and/or fragmented identity of the user through each of the persona profiles in which a context may be provided to each social interaction of the user with other users. The method may include organizing each of the specific contacts through semantics including contact introduced by person/entity>, met at <show name>, works at <company name>, and/or interests include <interest name>. In addition, a different persona profile may be expressed based on individual relationships semantics.

Moreover, the method may include classifying the persona profiles as an invisible persona profile, a confidential persona profile, and/or a public persona profile, in which the invisible persona profile is accessible only by the user after applying a vault key that may enable an invisible relationship in the invisible persona profile and/or invisible contacts and/or invisible groups are made visible only when the vault key is applied.

The confidential persona profile may include relationships with groups communicating between the user and/or other users who may be restricted to specific groups of trusted users having a contextual relationship with the user, and/or the public profile that includes relationships that are sharable with any known and/or unknown parties in the communications system.

In another aspect, a communications system includes a network, any number of content modules each having an embedded communication module to manage relationships between a user and other users of each of any number of the content modules, and the management module to communicate through the network with any number of the content modules and to classify relationships in each of the content modules as having an invisible communication profile, a confidential communication profile, and a public communication profile based on a behavior of the user associated with any number of the content modules.

The communications system may further include a feedback module of the management module to analyze intelligence gathered from personal representation of the user to other users, perception of other users, behavior analysis of the user and/or linked other users through a relationships behavior compounding algorithm, and/or collective contact rating of peers to determine an order of display of a unitary user profile in the management module of each of groups in the embedded communication module.

In addition, the feedback module may automatically assign a set of overridable specialized facets based on the behavior of the user including a family facet having a family relationships constructor, a work facet having an organization chart constructor, and/or a social facet having an activity classifier to enable the user to manifest specialized facets in context of a particular scenario of communications.

Furthermore, the communication system may include a vault module in which the invisible communication profile may be viewable simultaneously with the confidential communication profile and/or the public communication profile through a tiered authentication technique enabled through the management module.

In yet another aspect, a method of a content module includes expressing of a persona of a user in the content module through a communication of the user with other parties, associating with the persona specific contacts and groups associated with the user's behaviors, activities, and preferences in the content module, and sharing the persona with the management module that generates relationships of the user across any number of the content modules through a unified view in which each relationship is independent of the persona currently activated and which is common across past, current, and future content modules.

Also, the method may include providing a feedback rating through intelligence gathered from personal representation of the user to other users, perception of the other users, and behavior analysis of the user and/or linked other users through a relationships behavior compounding algorithm, and/or collective contact rating of peers.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a management module communicating with a content module through a network, according to one embodiment.

FIG. 2 is an exploded view of the management module of FIG. 1, according to one embodiment.

FIG. 3 is an exploded view of a shared context module of FIG. 1, according to one embodiment.

FIG. 4 is a table view of information associated with the different persona profiles, according to one embodiment.

FIG. 5 is a user interface view of the shared context module of FIG. 1, according to one embodiment.

FIG. 6 is a diagrammatic system view of a data processing system in which any of the embodiments disclosed herein may be performed, according to one embodiment.

FIG. 7 is a user interface view of a profile, according to one embodiment.

FIG. 8 is a user interface view of a shared page, according to one embodiment.

FIG. 9 is a user interface view of a my page, according to one embodiment.

FIG. 10 is a user interface view of a search tool, according to one embodiment.

FIG. 11 is a user interface view of a time zoom, according to one embodiment.

FIG. 12A is a process flow of creating a persona profile of the user, according to one embodiment.

FIG. 12B is a continuation of the process flow of FIG. 12A showing additional processes, according to one embodiment.

FIG. 13 is a process flow of expressing a persona of the user in the content module, according to one embodiment.

Other features of the present embodiments will be apparent from the accompanying drawings and from the detailed description that follows.

### DETAILED DESCRIPTION

A method, system and apparatus of contextual persona management in a communication medium to enhance relationship based interaction are disclosed. In the following description, for the purposes of explanation, numerous specific details are set forth in order to provide a thorough understanding of the various embodiments. It will be evident, however to one skilled in the art that the various embodiments may be practiced without these specific details.

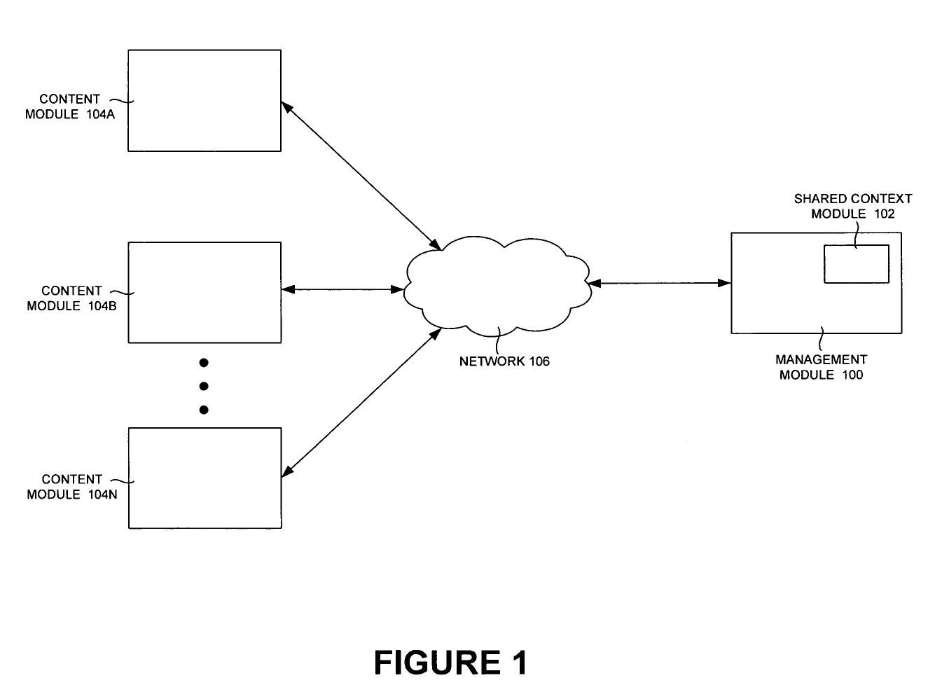

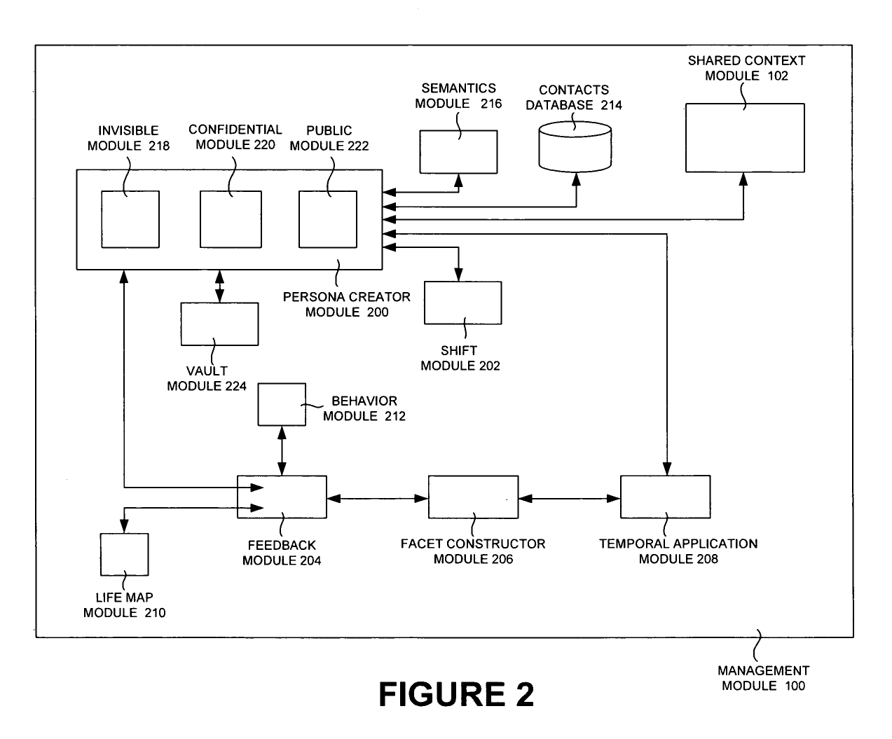

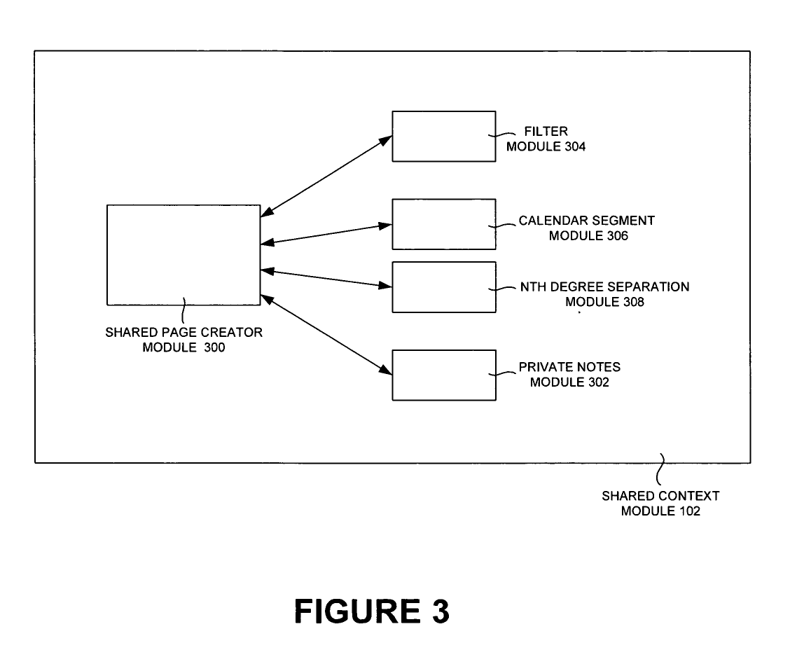

In one embodiment, a method of a communication system includes creating a persona profile (e.g., using the persona creator module 200 of FIG. 2) having contacts of a user (e.g., friends, associates, users having shared interests, etc.) in a specific context of expression, generating in the persona profile, representations of contacts and/or interest groups between the user and the contacts (e.g., using the share context module 102 of FIG. 1) and shifting a pane between the persona profile and other persona profiles while maintaining a relationship between the user and a particular contact which is independent of the persona profile and/or the other persona profiles (e.g., using the shared page creator 300 of FIG. 3).

In another embodiment, a communications system includes the network (e.g., the network 106 of FIG. 1), content modules (e.g., the content modules 104A-N of FIG. 1) each having an embedded communication module to manage relationships between a user and other users of each of the content modules and/or the management module (e.g., the management module 100 of FIG. 1-2) to communicate through the network (e.g., internet) with the content modules and/or to classify relationships in each of the content modules (e.g., the content modules 104A-N of FIG. 1) as having an invisible communication profile, a confidential communication profile, and/or a public communication profile based on a behavior of the user associated with each of the content modules.

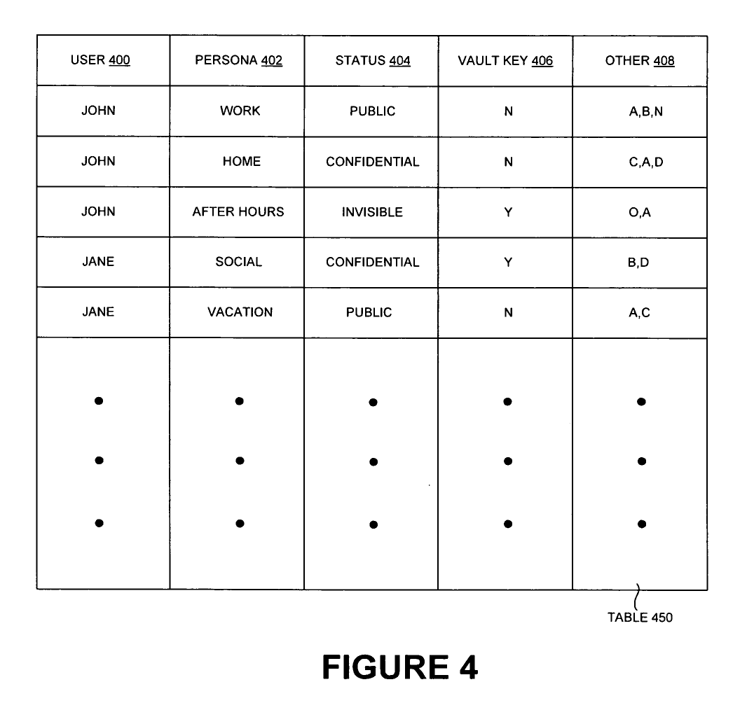

In yet another embodiment, a method of a content module (e.g., the content modules 104A-N of FIG. 1) includes expressing of a persona (e.g., the persona 402 of FIG. 4) of a user in the content module through a communication of the user with other parties, associating with the persona (e.g., the persona 402 of FIG. 4) specific contacts and/or groups associated with the user's behaviors, activities, and/or preferences in the content module and/or sharing the persona with the management module (e.g., the management module 100 of FIG. 1-2) that generates relationships of the user across a plurality of the content modules through a unified view in which each relationship is independent of the persona (e.g., the persona 402 of FIG. 4) currently activated and/or which is common across past, current, and/or future content modules.

FIG. 1 is a system view of a management module 100 communicating with a content module 104A-N through a network 106, according to one embodiment. Particularly, FIG. 1 illustrates the management module 100, a shared context module 102, the content module 104A-N and the network 106, according to one embodiment.

The management module 100 may generate and/or classify the relationships (e.g., the relationships may be independent of the persona currently generated) of the user from the shared persona across the content modules. The management module 100 may also analyze an intelligence (e.g., the intelligence may be drawn together from the perception of the other user, behavior analysis of the user, personal representation of the user to the others user, etc.) to determine the order of display of a unitary user profile.

The shared context module 102 may generate a shared page to manifest the interaction relevant to the communication between the particular user and the other user across personal profiles in any one of the activities, events, communications, etc. The shared context module 102 may generate the shared page (e.g., that may facilitate the particular user to express interaction in the form of the documents, events and communication, etc.).

The content modules 104A-N may convert the data to information (e.g., behavior, preferences, and/or activities of the particular user) associated with the particular user of the communication system. The content modules 104A-N may contain communication modules that manage relationships between particular user and the other users of the communication system. The network 108 (e.g., internet, LAN, telecommunications network, wireless network, etc.) may be a gateway for efficient communication between the management module 100 and content module 104A-N. In the example embodiment illustrated in FIG. 1, the management module 100 may communicate with the content modules 104A-N through the network 106.

For example, a communications system may include the network (e.g., the network 106 of FIG. 1). The communications system may include the content modules (e.g., the content modules 104A-N of FIG. 1) each having an embedded communication module to manage the relationships between a user (e.g., the user 400 of FIG. 4) and the other users of each of the content modules (e.g., the content module 104A-N of FIG. 1). Furthermore, the communications system may include the management module (e.g., the management module 100 of FIG. 1-2) to communicate through the network (e.g., the network 106 of FIG. 1) with the content modules 104A-N and/or to classify relationships in each of the content modules as having an invisible communication profile, a confidential communication profile, and/or a public communication profile based on a behavior of the user associated with each of the content module 104A-N.

In addition, the communications system may include a vault module 224 in which the invisible communication profile may be viewable simultaneously with the confidential communication profile and/or the public communication profile through a tiered authentication technique enabled through the management module 100. Furthermore, a persona 402 (e.g., a role, an identity, a personality, a character, etc.) of a user may be expressed in the content module (e.g., the content modules 104A-N of FIG. 1) through a communication of the user with other parties. The persona 402 may be associated with the specific contacts and/or groups associated with the user's behaviors, activities, and/or preferences in the content modules 104A-N.

Moreover, the persona (e.g., the persona 402 of FIG. 1) with the management module 100 that generates relationships of the user across the content modules 104A-N may be shared through a unified view in which each relationship is independent of the persona 402 currently activated and/or which is common (e.g., constant, pervasive) across past, current, and/or future content modules.

FIG. 2 is an exploded view of the management module 100 of FIG. 1, according to one embodiment. Particularly, FIG. 2 illustrates the shared context module 102, a persona creator module 200, a shift module 202, a feedback module 204, a facet constructor module 206, a temporal application module 208, a life map module 210, a behavior module 212, a contacts database 214, a semantics module 216, an invisible module 218, a confidential module 220, a public module 222, a vault module 224, according to one embodiment.

The persona creator module 200 may contain the invisible module 218, the confidential module 220, and the public module 222. The persona creator module 200 may create and/or update a persona profile that may contain contacts of a user in a specific context (e.g., the context may facilitate social interaction of the particular user with the other user) of expression. The shift module 202 may alter between the shared page and the other shared pages without affecting the relationship between the particular user and the other users which may be independent of currently utilized personal profiles.

The feedback module 204 may analyze the intelligence through a relationship behavior compounding algorithm and/or a collective contact rating of peers. In addition, the feedback module 204 may determine an order of the display of a unitary user profile. The facet constructor module 206 may be a family relationship constructor, an organization chart constructor, and/or an activity classifier that may enable the particular user to manifest specialized facets (e.g., a family facet, a work facet, a social facet, etc.) in context of a particular scenario of communications.

The temporal application module 208 may apply a temporal aspect to each of the facet through the facet constructor module 206 based on a propensity that may be user determined and/or automatically determined through a usage pattern mapping. Similarly, the temporal application module 208 may apply temporal aspects to each of the facets to enable a time based priority ranking of the particular contact with the other contacts.

The life map module 210 may generate life maps of the user in which the differing activities and/or behaviors of the user may be expressed in an electronic environment. The behavior module 212 may carry out the behavior analysis of the user and/or linked other users to provide the intelligence information (e.g., data and/or meta-data) to the feedback module 204. The contacts database 214 may contain the information associated with the contact details of the user of the communication system. The semantics module 216 may organize the specific contacts introduced by person/entity>, met at <show name>, works at <company name>, and/or interest include <interest name>.

The invisible module 218 may allow the user to access the invisible persona profile when a proper vault key is applied. Also, the invisible module 218 may enable an invisible relationship in the invisible persona profile and/or the invisible contacts and/or the invisible groups on application of the proper vault key by the user of the communication system.

The confidential module 220 may generate the confidential persona profile that may include relationships with the groups in which the communication between the user and the other users are restricted to the specific groups of trusted users who have a contextual relationship with the user. The public module 222 may create a public profile that may include the relationships that may be sharable with any known and/or unknown parties in the communications system. The vault module 224 may enable the user to view the invisible communication profile simultaneously with the confidential communication profile and public communication profile through a tiered authentication technique. The vault module 224 may facilitate the user to access the invisible communication profile in visible mode when user applies a correct vault key.

In example embodiment illustrated in FIG. 2, the persona creator module 200 may communicate with the shift module 202, the feedback module 204, the temporal application module 208, the contact database 214, and/or the semantics module 216. Also, the persona creator module 200 may interact with the shared context module 102 of FIG. 1 as illustrated in the example embodiment of FIG. 2. Furthermore, the feedback module 204 may communicate with the facet constructor module 206, the life map module 210, the behavior module 212. The facet constructor module 206 as illustrated in example embodiment of FIG. 2 may also communicate with the temporal application module 208.

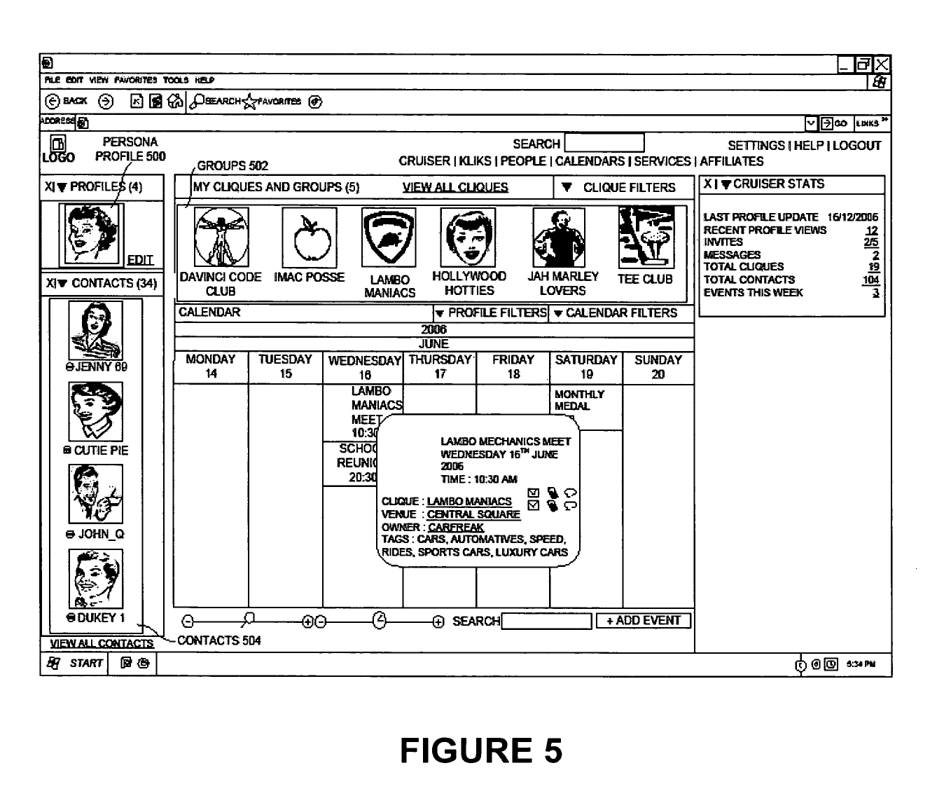

For example, a persona profile (e.g., the persona profile 500 of FIG. 5) having contacts of the user may be created in a specific context of expression. Also, representations of contacts and/or interest groups may be generated in the persona profile (e.g., the persona profile 500 of FIG. 5) between the user and the contacts. In addition, a pane may be shifted between the persona profile and other persona profiles while maintaining a relationship between the user and a particular contact which is independent of the persona profile (e.g., the persona profile 500 of FIG. 5) and/or the other persona profiles.

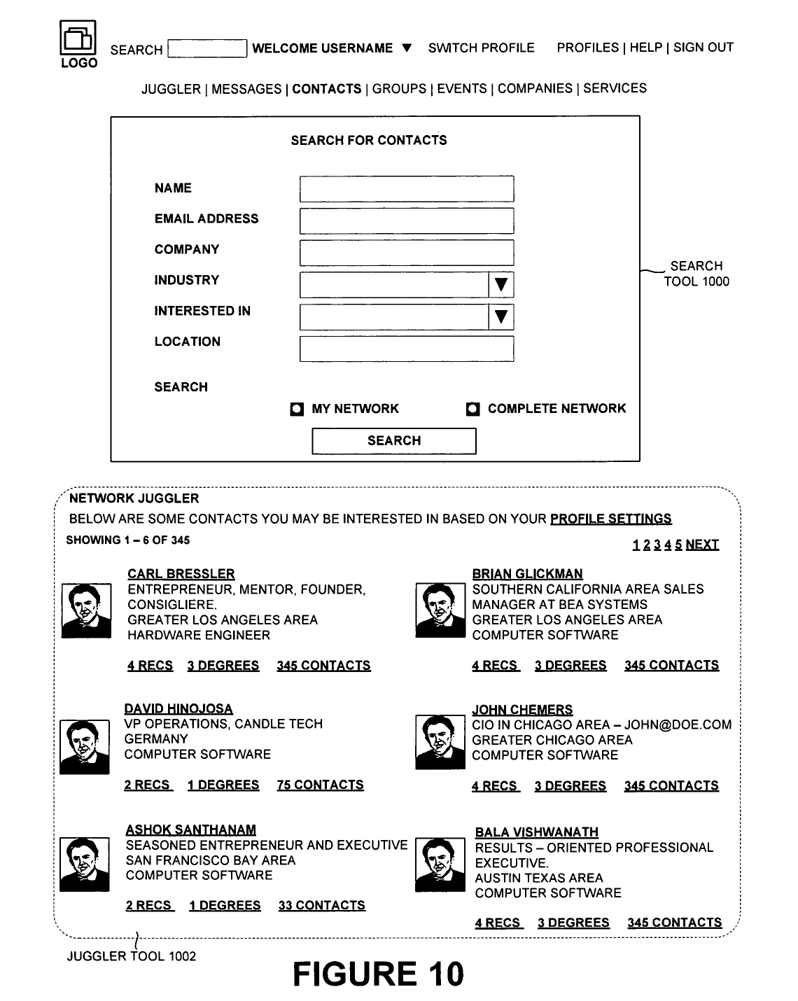

Furthermore, different contacts in each of the persona profiles (e.g., the persona profile 500 of FIG. 5) may be juggled (e.g., using the juggler tool 1002 as illustrated in FIG. 10) between based on at a behavior of the user (e.g., the user 400 of FIG. 4) and/or a feedback rating (e.g., of the user 400) provided by other parties. Also, the feedback ratings may be provided through intelligence gathered from personal representation of the user 400 to other users, perception of other users, behavior analysis of the user 400 and/or linked other users through a relationship behavior compounding algorithm, and/or collective contact rating of peers.

Moreover, facets may be enabled through the feedback ratings that are created through implicit and/or explicit techniques based on trust, affinity, and/or propensity of interaction and/or in which multiple facets coexist in each persona profile (e.g., the persona profile 500 of FIG. 5) and/or which develop a set of rankings of the user (e.g., the user 400 of FIG. 4) with other users through each of the facets. A temporal aspect may be applied to each of the facets based on the propensity that is the user determined and/or automatically determined through a usage pattern mapping of the user 400 with facets associated with the user to enable a time based priority ranking of the particular contact with other contacts.

In addition, a set of overridable specialized facets (e.g., processed using the facet constructor module 206 of FIG. 2) may be automatically assigned based on the behavior of the user including a family facet having a family relationship constructor), a work facet having an organization chart constructor, and/or a social facet having an activity classifier) to enable the user to manifest specialized facets in context of a particular scenario of communications. Also, a life map (e.g., an integrated and/or holistic representation of attributes) of the user may be generated (e.g., using the life map module 210 of FIG. 2) in which differing activities and/or the behaviors of the user (e.g., the user 400 of FIG. 4) may be simultaneously expressed in the electronic environment.

Moreover, the life map may be organized around a common marker chosen between people, communications, events, groups, places, messages, money, and/or content including music, books, and/or news feeds. Also, each of the specific contacts may be organized through the semantics including contact introduced by person/entity>, met at <show name>, works at <company name>, and/or interests include <interest name>. Furthermore, the different persona profile may be expressed based on individual relationship semantics.

In addition, the confidential persona profile (e.g., associated with the confidential module 220 of FIG. 2) may include the relationships with the groups in which the communication between the user (e.g., the user 400 of FIG. 4) and the other users are restricted to the specific groups of the trusted users who have a contextual relationship with the user, and/or in which the public profile (e.g., associated with the public module 222 of FIG. 2) includes relationships that are sharable with any known and/or unknown parties in the communications system.

In addition, the communications system may include the feedback module (e.g., the feedback module 204 of FIG. 2) of the management module (e.g., the management module 100 of FIG. 1-2) to analyze the intelligence gathered from personal representation of the user to other users, the perception of the other users, the behavior analysis of the user and linked other users through the relationship behavior compounding algorithm, and/or the collective contact ratings of peers to determine an order of display of a unitary user profile in the management module (e.g., the management module 100 of FIG. 1-2) of each of groups in the embedded communication module.

Also, the feedback module 204 may be automatically assign the set of overridable specialized facets based on the behavior of the user (e.g., the user 400 of FIG. 4), including the family facet having a family relationship constructor, a work facet having an organization chart constructor, and/or a social facet having an activity classifier to enable the user to manifest specialized facets in context of a particular scenario of communications.

The communications system may further include a vault module 224 in which the invisible communication profile may be viewable simultaneously with the confidential communication profile and/or the public communication profile through a tiered authentication technique enabled through the management module (e.g., the management module 100 of FIG. 1-2).

Furthermore, the feedback rating (e.g., a value, an indicator, a visual representation) may be provided through the intelligence gathered from personal representation of the user (e.g., the user 400 of FIG. 4) to the other users, the perception of other users, the behavior analysis of the user and the linked other users through the relationship behavior compounding algorithm, and/or the collective contact rating of peers.

FIG. 3 is an exploded view of the shared context module 102 of FIG. 1, according to one embodiment. Particularly, FIG. 3 illustrates a shared page creator 300, a private notes module 302, a filter module 304, a calendar segment module 306 and a nth degree separation module 308, according to one embodiment.

The shared page creator 300 may generate shared pages that contain the communications, documents and/or events relevant to communications between the particular user and other users of the communication system. In addition, the shared page creator 300 may customize the shared page based on the relationship modality of the particular user with the other users, based on the specialized facet determined, based on the behavior and/or association of the particular user including a family. The private notes module 302 may generate a set of private notes of the particular user about the other user associated and linked with shared page.

The filter module 304 may categorize the shared page generated by the shared page creator 300 based on a temporal criteria specified by the particular user. The calendar segment module 306 may determine a segmentible calendar in the shared page that may illustrate (e.g., visually) interaction solely between the particular user and combination of the other user and non-users. The nth degree separation module 308 may embed any groups and/or the users common to the particular user and/or the other user through nth degree separations (e.g., levels of abstraction of association, degrees of interpersonal relevance) in the shared paged created by the shared page creator 300.

In the example embodiment illustrated in FIG. 1, the shared page creator 300 may communicate with the private notes module 302, the filter module 304, the calendar segment module 306, and the nth degree separation module 308.

FIG. 4 is a table view of information associated with the different persona profiles, according to one embodiment. Particularly, FIG. 4 illustrates a user field 400, a persona field 402, a status field 404, a vault key field 406, and other field 408, according to one embodiment.

The table 450 of FIG. 4 illustrates information associated with the different persona profiles (e.g., name of the user, the persona, status of the persona profile, a vault key status, etc.). The user field 400 may display names of the user associated with the particular persona profile. The persona field 402 may display the different contexts of communication that may be taking place between the particular user and other parties. The Status field 404 may display the information associated with the status of the persona profile of the particular user.

The vault key field 406 may display whether the particular user has access to the vault keys (e.g., the vault key may enable the user to access the invisible persona profile.). The other field 408 may display other information associated with the user (e.g., feedback rating of the user, contacts list, events, company name, etc.).

In example embodiment illustrated in FIG. 4, the user field 400 displays “JOHN” in the first row, “JOHN” in the second row, “JOHN” in the third row, “JANE” in the fourth row, and “JANE” in the fifth row of the user field 400 column of the table 450. The persona field 402 as illustrated in example embodiment of FIG. 4 displays “WORK” in the first row, “HOME” in the second row, “AFTER HOURS” in the third row, “SOCIAL” in the fourth row, and “VACATION” in the fifth row of the persona 402 column of the table 450.

The status field 404 displays “PUBLIC” in the first row, “CONFIDENTIAL” in the second row, “INVISIBLE” in the third row, “CONFIDENTIAL” in the fourth row, and “PUBLIC” in the fifth row of the status field 404 column of the table 450. The vault key field 406 displays “N” in the first row, “N” in the second row, “Y” in the third row, “Y” in the fourth row, “N” in the fifth row of the vault key field 406 column of the table 450 of FIG. 4.

In the example embodiment illustrated in FIG. 4, the other field 408 displays “A, B, N” in the first row, “C, A, D” in the second row, “O, A” in the third row, “B, D” in the fourth row, and “A, C” in the fifth row of the other field 408 column of the table 450 of FIG. 4.

For example, the persona profiles (e.g., the persona profile 500 of FIG. 5) are displayed as including an “Invisible” persona profile, a “Confidential” persona profile, and a “Public” persona profile. The “Invisible” persona profile may be accessible by the user (e.g., the user 400 of FIG. 4) only after applying a vault key (e.g., the vault key 406 of FIG. 4) that enables an invisible relationship in the “Invisible” persona profile (e.g., the persona profile 500 of FIG. 5), and/or invisible contacts and invisible groups are made visible only when the vault key (e.g., the vault key 406 of FIG. 4) is applied.

FIG. 5 is a user interface view of the shared context module 102 of FIG. 1, according to one embodiment. Particularly, FIG. 5 illustrates the persona profile 500, groups 502 and contacts 504, according to one embodiment. The persona profile 500 may comprise the contacts of the user in a specific context of expression sharing the identity of the user in which a context is provided to each social interaction of the particular user with other users.

The groups 502 may display communications between the particular user and the other users (e.g., restricted to specific trusted users who may have the contextual relationship with the user). For example, the public profile displayed in the groups 502 view may include the relationships shared with known and/or unknown parties in the communications system. The contacts 504 may be the specific contacts and/or groups associated with the user's behaviors, activities, and/or preferences in the communication system.

In example embodiment illustrated in FIG. 5, the user associated with the communication system may view the persona profile 500 of a particular user profile (e.g., displaying the particular user's contacts, image and/or profile). The contacts 504 may consist of profiles of other users (e.g., friends, partners, relatives, etc.) related to the particular user profile, and/or displaying their images, profile, contacts, etc. The groups 502 may include the groups (e.g., groups may be based on behaviors, activities, preferences, favorite clubs, personality, organization, etc.) associated with the particular user (e.g., may be restricted to specific trusted users having the contextual relationship with the user). For example, the groups 502 view may contain the images and/or the profiles of the particular user and/or the other users relevant to the particular group which the particular user is linked with.

For example, a faceted and/or fragmented identity of the user (e.g., the user 400 of FIG. 4) through each of the persona profiles (e.g., persona profile 500 of FIG. 5) in which a context is provided to each social interaction of the user with the other users. Also, the persona (e.g., the persona 402 of FIG. 4) of a user may be expressed in the content module (e.g., the content module 104A-N of FIG. 1) through the communication of the user with the other parties

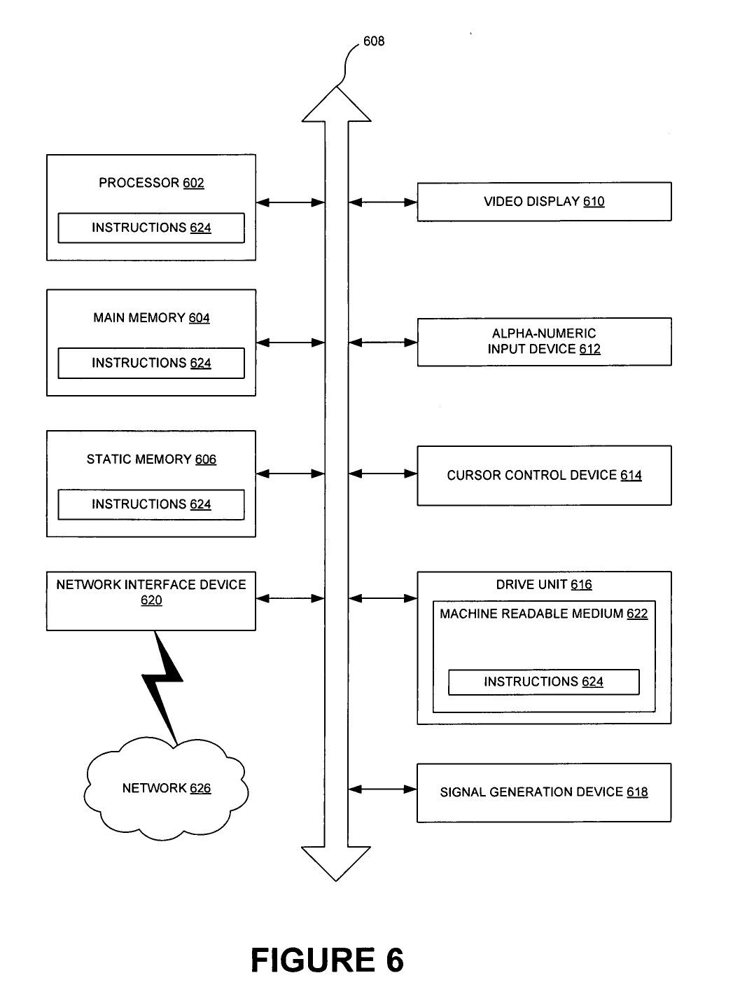

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from a network. The machine readable medium 622 may provide instructions on which any of the methods disclosed herein may be performed. The instructions 624 may provide source code and/or data code to the processor 602 to enable any one/or more operations disclosed herein.

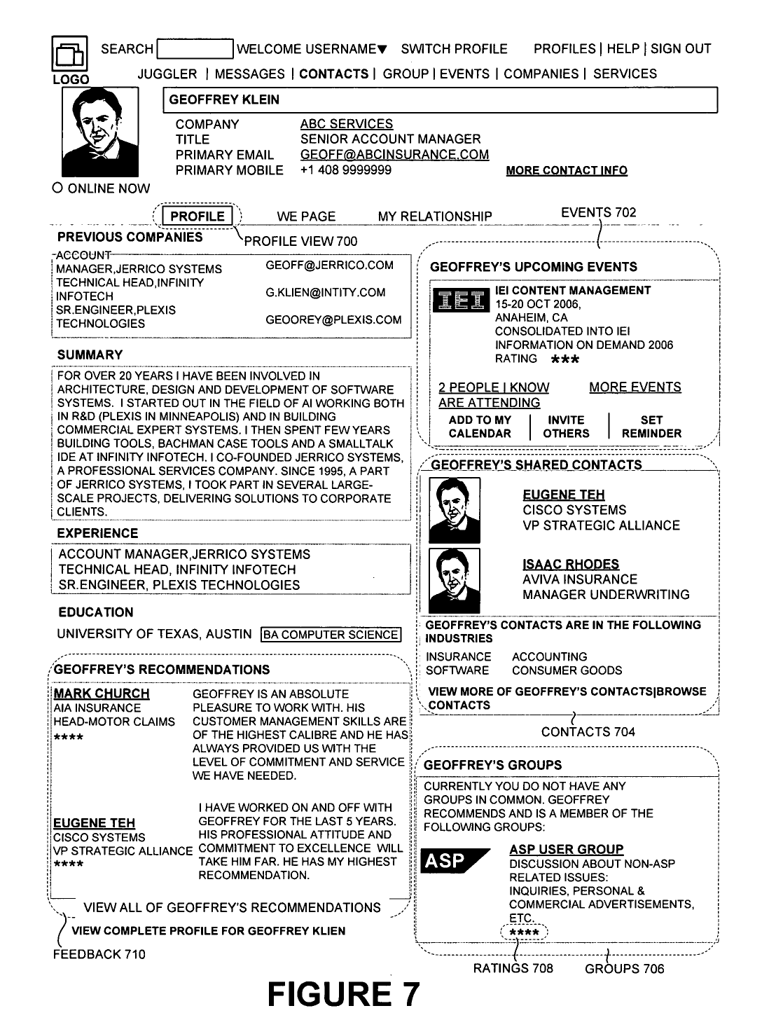

FIG. 7 is a user interface view of the profile, according to one embodiment. Particularly, FIG. 7 illustrates the profile view 700, events 702, contacts 704, groups 706, ratings 708 and a feedback 710, according to one embodiment.

The profile view 700 may display the profile information of the particular user in the communication system. The profile view 700 may display the information such as names of previous companies, a summary of work experience, designations in the previous companies, an educational details of the user, the contact details, etc. The events 702 may display upcoming the events uploaded by the particular user that may be the events of interest. The contacts 704 may facilitate the user of the communication system to view the information associated with the shared contacts of the particular user.

The contacts 704 may also enable the user to view organization types in which the particular user may have contacts. The groups 706 may display the group(s) in which the particular user may have joined as the member. In addition, the groups 706 may display status information associated with the group of the particular user. The ratings 708 may enable the user to view the rating of each individual group associated with the particular user. The feedback 710 may display recommendations made by the other users (e.g., shared contacts) and/or may also display feedback ratings (e.g., calculated through the behavior analysis of the user and/or linked other users, the perception of other users and/or the personal representation of the user to the other users).

In the example embodiment illustrated in FIG. 7, the profile view 700 displays profile information for “Geoffrey Klein,” that may contain details of the previous companies where Geoffrey Klein used to work, the summary of the work experience, Geoffrey's designation(s) in the previous companies, an educational details of Geoffrey, an email ID, contact details for Geoffrey etc. The events 702 view as illustrated in the example embodiment of FIG. 7 displays Geoffrey's upcoming events (e.g., that he is interested in). For example, Geoffrey may be interested in an “IEI content management” event which is illustrated as being scheduled on 15-20 Oct. 2006 at Anaheim, Calif.

In the example embodiment illustrated in FIG. 7 the contacts 704 displays the information associated with Geoffrey's shared contacts and/or displays the industries in which Geoffrey may have contacts. For example Geoffrey may have contacts in an Insurance, an Accounting, an Automotive, a Finance, a Software, Consumer goods, and/or CRM industries. The groups 706 as illustrated in example embodiment of FIG. 7 displays the recommended groups of which Geoffrey is a member.

The ratings 708 may display the ratings provided for each group in which Geoffrey is the member. In the example embodiment illustrated in FIG. 7, the feedback 710 displays Geoffrey's recommendations created by “Mark Church” and “Eugene ”teh” who may know Geoffrey through different contexts of communication. The feedback 710 view also displays the organizations, designations and/or ratings associated with Mark Church and Eugene Teh. For example, the faceted and/or fragmented identity of the user (e.g., the user 400 of FIG. 4) through each of the persona profiles (e.g., the persona profile 500 of FIG. 5) in which the context may be provided to each social interaction of the user with other users.

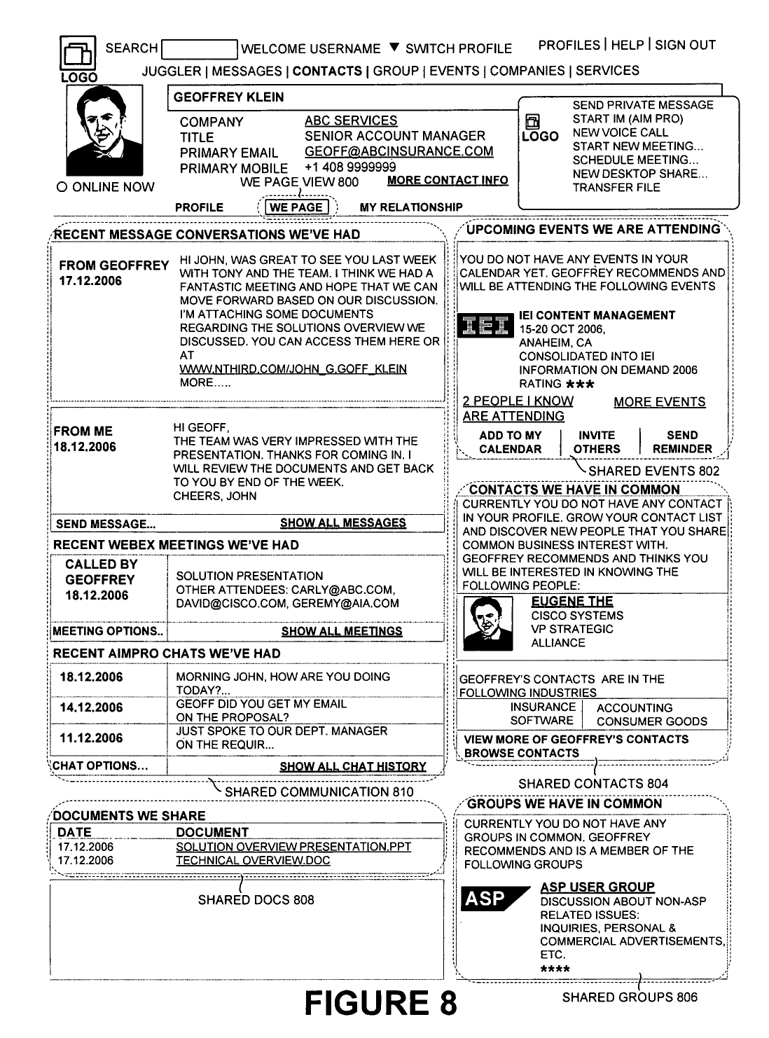

FIG. 8 is a user interface view of a shared page, according to one embodiment. Particularly, FIG. 8 illustrates a we page view 800, shared events 802, shared contacts 804, shared groups 806, shared docs 808 and a shared communication 810, according to one embodiment. The we page view 800 may provide the user information associated with communications between the users of the communication system, upcoming events, common groups and/or contacts. The shared events 802 may provide information associated with the upcoming events to the particular user of the communication system. The user may be provided with information like time, date, venue, number of people attending and/or ratings of the event.

The shared contacts 804 may display contacts of the users having common interests and/or may also provide the information associated with the other users. The shared groups 806 may display groups having common interests and/or may also provide the information associated with the other groups. The shared docs 808 may enable the user of the communication system to manage documents shared among the other users. The shared communication 810 may enable the user to communicate with other users associated with the communication system. For example Geoffrey may send/receive messages to/from John, who may be a shared user of the shared page.

For example, the confidential persona profile (e.g., the confidential module 220 of FIG. 2) may include relationships (e.g., of the user) with groups in which communication between the user (e.g., the user 400 of FIG. 4) and other users are restricted to the specific groups (e.g., the groups 502 of FIG. 5) of the trusted users who have the contextual relationship with the user, and/or in which the public profile includes the relationships that are sharable with any known and/or unknown parties in the communications system.

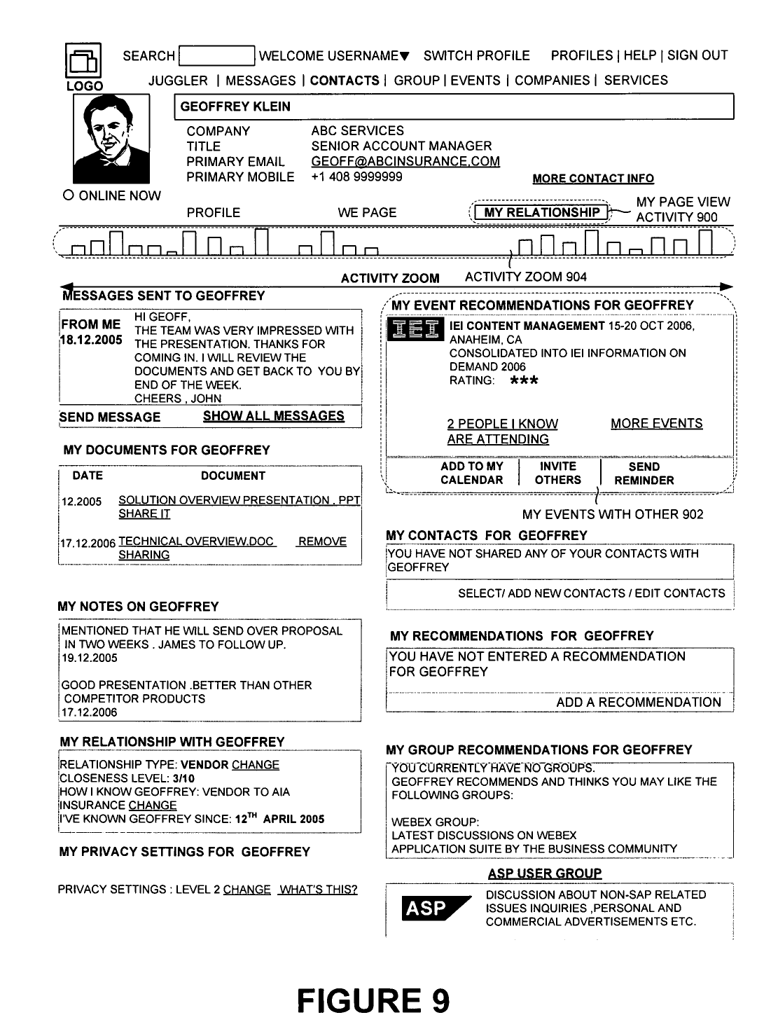

FIG. 9 is a user interface view of a my page, according to one embodiment. Particularly, FIG. 9 illustrates a my page view 900, a my events with other view 902 and an activity zoom 904, according to one embodiment. The my page view 900 may provide the user with the information related to events, messages, documents, notes, relations, privacy settings, contacts, and/or recommendations (e.g., from/by other users). The activity zoom 904 may enable the user to view plans of activities (e.g., events, scheduled in a graph format). The my events with other view 902 may provide the particular user with information associated with the events and/or schedules (e.g., time, date, venue, number of people attending and/or the rating of the event).

In the example embodiment illustrated in FIG. 9, users may provide the particular user with information associated with the events. For example, the recommendation may indicate that the event is by the “IEI content management,” as illustrated to be scheduled on “15-20 October” in “Anaheim, Calif., and being “consolidated into IEI Information on demand 2006,” and/or two people may be attending the event. The event may be also rated depending on the interests of the user and/or the strength of the recommendation (e.g., by another user). For example, a different persona profile may be expressed based on individual relationship semantics.

FIG. 10 is a user interface view of a search tool 1000, according to one embodiment. Particularly, FIG. 10 illustrates a search tool 1000 and a juggler tool 1002, according to one embodiment. The search tool 1000 may enable the user of the communication system to conduct a search for other user by providing details (e.g., by the user's interests based on the profile settings). The juggler tool 1002 may organize and/or display contacts (e.g., using semantics) including contacts obtained based on search results.

In the example embodiment illustrated in FIG. 10, the communication system may provide the user with the search tool 1000. The user may conduct a search for other users by providing their information in the name, the email address, the company, an industry, interested in and/or location blocks of the search tool 1000. The search in the communication system may be conducted in the network of the user and/or in the complete (e.g., larger) network by selecting the “my network” and/or “complete network” options.

The search result and/or the information related to the searched contacts may be displayed in the juggler tool. For example the photos, names, addresses, professions, etc of the other users may be displayed in the juggler tool 1002 of the communication system.

For example, each of the specific contacts may be organized (e.g., using semantic analysis), including contact introduced by person/entity>, met at <show name>, works at <company name>, and/or interests include <interest name>.

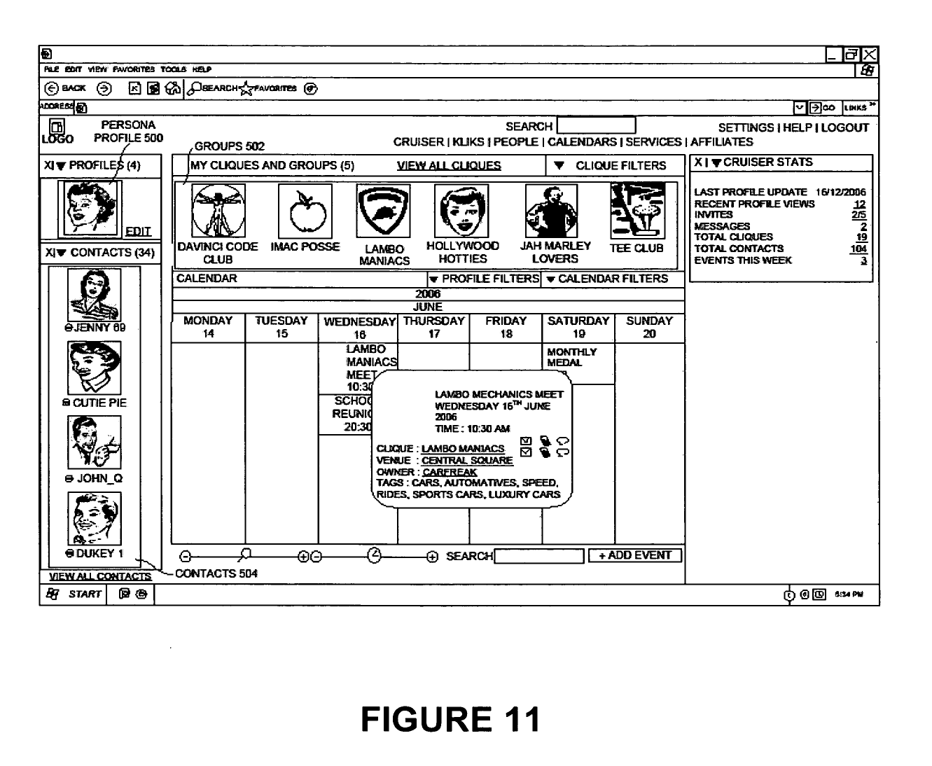

FIG. 11 is a user interface view of a time zoom 1100, according to one embodiment. Particularly, FIG. 11 illustrates the time zoom 1100, relevant contacts 1102, relevant clicks 1104 and a calendar 1106, according to one embodiment. The time zoom 1100 may enable a time based priority ranking of a particular contact (e.g., of the particular user) with the other contacts in the communication system. For example, the particular user may track the level of involvement with other users at a particular instant in time.

The relevant contacts 1102 may display the contacts (e.g., profiles) of the other users in sections associated with the particular user in the communication system. The relevant contacts 1102 may enable the particular user to communicate with any other user from the list by selecting the profile of the other user in the communication system. The relevant clicks 1104 may display the groups (e.g., groups may be based on associations such as particular behavioral traits, activities, preferences, favorite clubs, personalities, organizational affiliations, etc) in sections associated with the particular user in the communication system. The relevant contacts 1102 may enable the particular user to select any groups from the list in the communication system for any interaction with the other users in the group. The calendar 1106 may enable the user to trace and/or keep a track of schedule of the events of importance and/or interest to the particular user.

In the example embodiment illustrated in FIG. 11, the user associated with the communication system may trace the level of involvement with other users at a particular instant in time, in the time zoom 1100. The relevant contacts 1102 may provide the information related to the other users associated with the user. For example, the relevant contacts 1102 may provide information about the other users (e.g., photos, profiles, names, contact information, interests of the users and/or status (e.g., online, busy, idle, offline, etc) of the users). The relevant contacts 1102 may contain a search window to effectively search for the other users' profiles, images etc. The relevant clicks 1104 may provide information about the groups associated with the particular user and/or search tools to search for other group profiles, images etc. The calendar 1106 may provide the user with a calendar that displays the year, month, day and/or time in which the user may feed the events of interest and/or importance (e.g., meeting, functions, birthday, etc) for further reference.

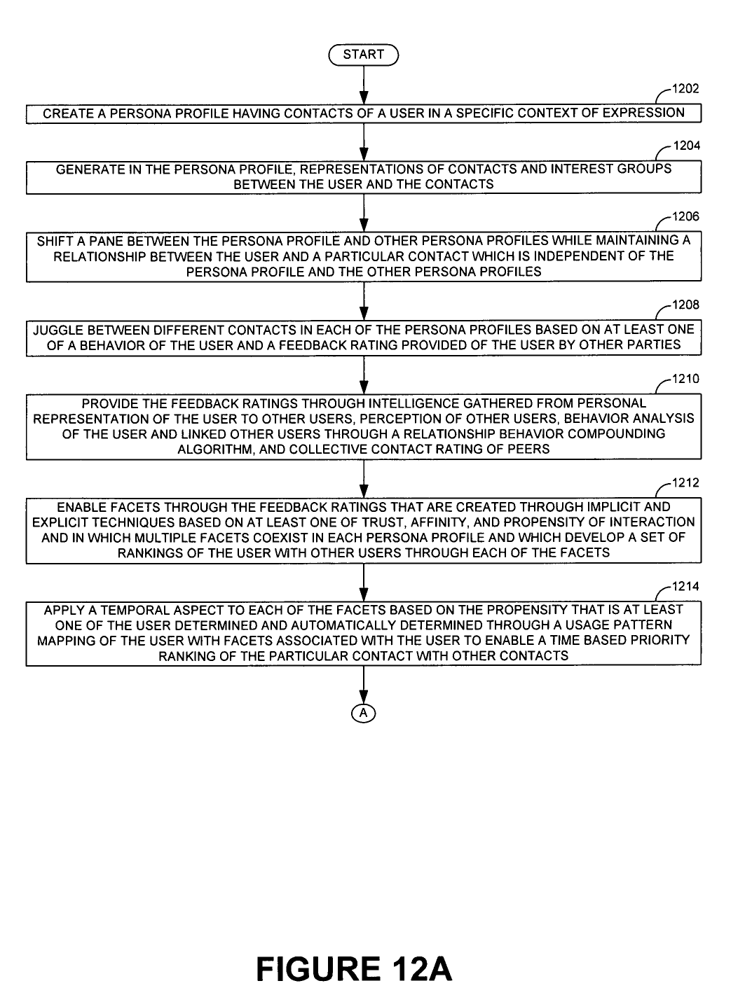

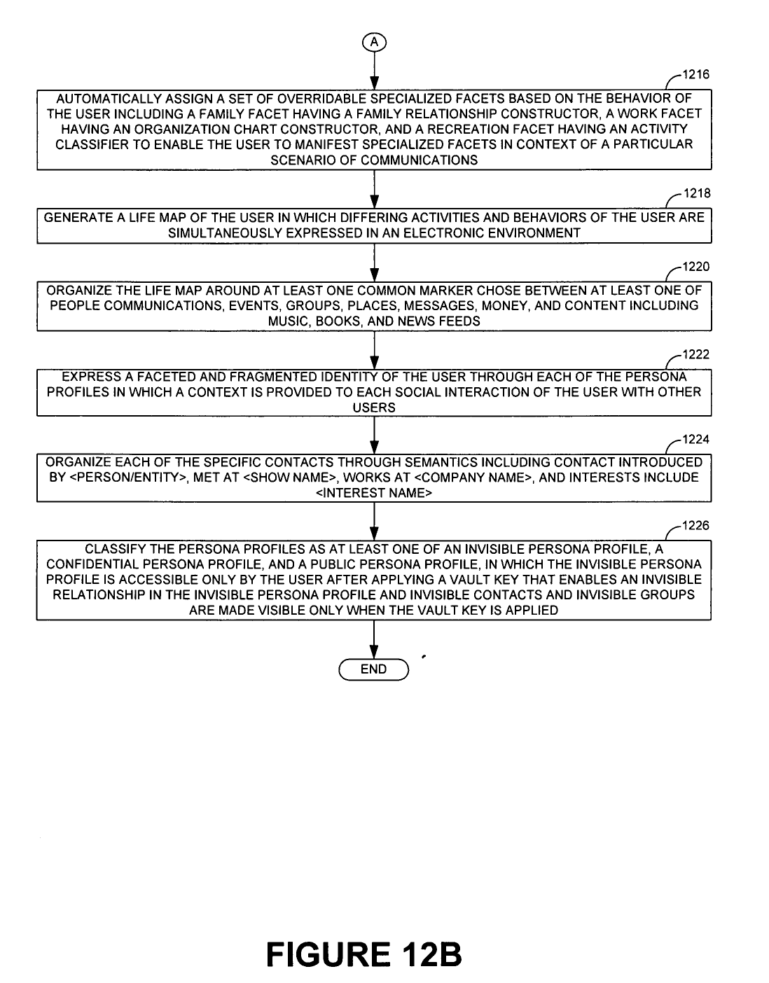

FIG. 12A is a process flow of creating a persona profile of the user, according to one embodiment. In operation 1202, a persona profile (e.g., the persona profile 500 of FIG. 5) having contacts of a user (e.g., the user 400 of FIG. 4) may be created in a specific context of expression. In operation 1204, in the persona profile (e.g., the persona profile 500 of FIG. 5), representations of contacts and/or interest groups may be generated between the user (e.g., the user 400 of FIG. 4) and/or the contacts. In operation 1206, a pane between the persona profile (e.g., the persona profile 500 of FIG. 5) and other persona profiles may be shifted while maintaining a relationship between the user (e.g., the user 400 of FIG. 4) and a particular contact which is independent of the persona profile (e.g., the persona profile 500 of FIG. 5) and/or the other persona profiles.

In operation 1208, Different contacts may be juggled between in each of the persona profiles (e.g., the persona profile 500 of FIG. 5) based on at least one of a behavior of the user (e.g., the user 400 of FIG. 4) and/or a feedback rating provided of the user (e.g., the user 400 of FIG. 4) by other parties. In operation 1210, the feedback ratings may be provided through intelligence gathered from personal representation of the user (e.g., the user 400 of FIG. 4) to other users, perception of other users, behavior analysis of the user (e.g., the user 400 of FIG. 4) and linked other users through a relationship behavior compounding algorithm, and/or collective contact rating of peers.

In operation 1212, facets may be enabled through the feedback ratings that are created through implicit and explicit techniques based on at least one of trust, affinity, and propensity of interaction and in which multiple facets coexist in each persona profile and which develop a set of rankings of the user (e.g., the user 400 of FIG. 4) with other users through each of the facets.

In operation 1214, a temporal aspect may be applied to each of the facets based on the propensity that is at least one of the user (e.g., the user 400 of FIG. 4) determined and automatically determined through a usage pattern mapping of the user (e.g., the user 400 of FIG. 4) with facets associated with the user (e.g., the user 400 of FIG. 4) to enable a time based priority ranking of the particular contact with other contacts.

FIG. 12B is a continuation of the process flow of FIG. 12A, showing additional processes, according to one embodiment. In operation 1216, a set of overridable specialized facets may be automatically assigned based on the behavior of the user (e.g., the user 400 of FIG. 4) including a family facet having a family relationship constructor, a work facet having an organization chart constructor, and a social facet having an activity classifier to enable the user (e.g., the user 400 of FIG. 4) to manifest specialized facets in context of a particular scenario of communications.

In operation 1218, a life map of the user (e.g., the user 400 of FIG. 4) may be generated in which differing activities and behaviors of the user (e.g., the user 400 of FIG. 4) are simultaneously expressed in an electronic environment. In operation 1220, the life map around at least one common marker chosen may be organized between at least one of people communications, events, groups, places, messages, money, and content including music, books, and news feeds. In operation 1222, a faceted and fragmented identity of the user (e.g., the user 400 of FIG. 4) may be expressed through each of the persona profiles in which a context is provided to each social interaction of the user (e.g., the user 400 of FIG. 4) with other users.

In operation 1224, each of the specific contacts may be organized through semantics including contact introduced by person/entity>, met at <show name>, works at <company name>, and interests include <interest name>. In operation 1226, the persona profiles (e.g., the persona profile 500 of FIG. 5) may be classified as an invisible persona profile, a confidential persona profile, and/or a public persona profile, in which the invisible persona profile is accessible only by the user (e.g., the user 400 of FIG. 4) after applying a vault key (e.g., the vault key 406 of FIG. 4) that enables an invisible relationship in the invisible persona profile and invisible contacts and invisible groups are made visible only when the vault key is applied (e.g., the vault key 406 of FIG. 4).

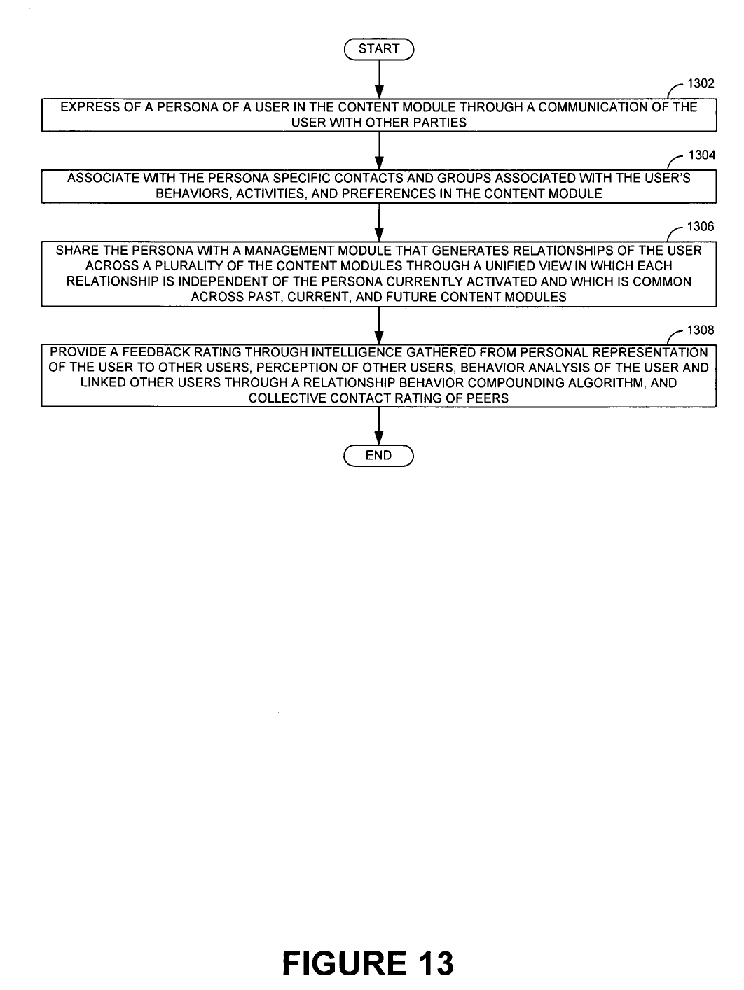

FIG. 13 is a process flow of expressing a persona of the user in the content module, according to one embodiment. In operation 1302, a persona (e.g., the persona 402 of FIG. 4) of a user (e.g., the user 400 of FIG. 4) in a content module (e.g., the content module 104A-N of FIG. 1) may be expressed through a communication of the user (e.g., the user 400 of FIG. 4) with other parties. In operation 1304, the persona may be associated with specific contacts and groups associated with the user's (e.g., the user 400 of FIG. 4) behaviors, activities, and preferences in the content module (e.g., the content module 104A-N of FIG. 1).

In operation 1306, the persona (e.g., the persona 402 of FIG. 4) may be shared with the management module (e.g., the management module 100 of FIG. 1-2) that generates relationships of the user (e.g., the user 400 of FIG. 4) across a plurality of the content modules (e.g., the content module 104A-N of FIG. 1) through a unified view in which each relationship is independent of the persona (e.g., the persona 402 of FIG. 4) currently activated and which is common across past, current, and future content modules (e.g., the content module 104A-N of FIG. 1).

In operation 1308, a feedback rating may be provided through intelligence gathered from personal representation of the user (e.g., the user 400 of FIG. 4) to other users, perception of other users, behavior analysis of the user (e.g., the user 400 of FIG. 4) and linked other users through a relationship behavior compounding algorithm, and collective contact rating of peers.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example the management module 100, the shared context module 102, the content module 104A-N, the persona creator module 200, the shift module 202, the feedback module 204, the facet constructor module 206, the temporal application module 208, the life map module 210, the behavior module 212, the semantics module 216, the invisible module 218, the confidential module 220, the public module 222, the vault module 224, the private notes module 302, the filter module 304, the calendar segment module 306, the nth degree separation module 308, and other modules of FIGS. 1-3 may be embodied through the management circuit, the shared context circuit, the content circuit, the persona creator circuit, the shift circuit, the feedback circuit, the facet constructor circuit, the temporal application circuit, the life map circuit, the behavior circuit, the semantics circuit, the invisible circuit, the confidential circuit, the public circuit, the private notes circuit, the filter circuit, the calendar segment circuit, the nth degree separation circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a communication system, comprising:
creating a persona profile having contacts of a user in a specific context of expression;
generating in the persona profile, representations of contacts and interest groups between the user and the contacts; and
shifting a pane between the persona profile and other persona profiles while maintaining a relationship between the user and a particular contact which is independent of the persona profile and the other persona profiles.

2. The method of claim 1 further comprising juggling between different contacts in each of the persona profiles based on at least one of a behavior of the user and a feedback rating provided of the user by other parties.

3. The method of claim 2 further comprising providing the feedback ratings through intelligence gathered from personal representation of the user to other users, perception of other users, behavior analysis of the user and linked other users through a relationship behavior compounding algorithm, and collective contact rating of peers.

4. The method of claim 3 further comprising enabling facets through the feedback ratings that are created through implicit and explicit techniques based on at least one of trust, affinity, and propensity of interaction and in which multiple facets coexist in each persona profile and which develop a set of rankings of the user with other users through each of the facets.

5. The method of claim 4 further comprising applying a temporal aspect to each of the facets based on the propensity that is at least one of the user determined and automatically determined through a usage pattern mapping of the user with facets associated with the user to enable a time based priority ranking of the particular contact with other contacts.

6. The method of claim 5 further comprising automatically assigning a set of overridable specialized facets based on the behavior of the user including a family facet having a family relationship constructor, a work facet having an organization chart constructor, and a social facet having an activity classifier to enable the user to manifest specialized facets in context of a particular scenario of communications.

7. The method of claim 1 further comprising generating a life map of the user in which differing activities and behaviors of the user are simultaneously expressed in an electronic environment.

8. The method of claim 7 further comprising organizing the life map around at least one common marker selected between at least one of people communications, events, groups, places, messages, money, and content including music, books, and news feeds.

9. The method of claim 1 further comprising expressing a faceted and fragmented identity of the user through each of the persona profiles in which a context is provided to each social interaction of the user with other users.

10. The method of claim 1 further comprising organizing each of the specific contacts through semantics including contact introduced by person/entity>, met at <show name>, works at <company name>, and interests include <interest name>.

11. The method of claim 10 in which a different persona profile is expressed based on individual relationship semantics.

12. The method of claim 1 further comprising classifying the persona profiles as at least one of an invisible persona profile, a confidential persona profile, and a public persona profile, in which the invisible persona profile is accessible only by the user after applying a vault key that enables an invisible relationship in the invisible persona profile and invisible contacts and invisible groups are made visible only when the vault key is applied.

13. The method of claim 12 in which the confidential persona profile includes relationships with groups in which communication between the user and other users are restricted to specific groups of trusted users who have a contextual relationship with the user, and in which the public profile includes relationships that are sharable with any known and unknown parties in the communications system.

14. A communications system comprising:
a network;
a plurality of content modules each having an embedded communication module to manage relationships between a user and other users of each of the plurality of the content modules; and
the management module to communicate through the network with the plurality of the content modules and to classify relationships in each of the content modules as having at least one of an invisible communication profile, a confidential communication profile, and a public communication profile based on a behavior of the user associated with each of the plurality of the content modules.

15. The communications system of claim 14 further comprising a feedback module of the management module to analyze intelligence gathered from personal representation of the user to other users, perception of other users, behavior analysis of the user and linked other users through a relationship behavior compounding algorithm, and collective contact rating of peers to determine an order of display of a unitary user profile in the management module of each of groups in the embedded communication module.

16. The communications system of claim 15 wherein the feedback module to automatically assigning a set of overridable specialized facets based on the behavior of the user including a family facet having a family relationship constructor, a work facet having an organization chart constructor, and a social facet having an activity classifier to enable the user to manifest specialized facets in context of a particular scenario of communications.

17. The communications system of claim 16 further comprising a vault module in which the invisible communication profile is viewable simultaneously with the confidential communication profile and the public communication profile through a tiered authentication technique enabled through the management module.

18. A method of a content module, comprising:
expressing of a persona of a user in the content module through a communication of the user with other parties;
associating with the persona specific contacts and groups associated with the user's behaviors, activities, and preferences in the content module; and
sharing the persona with the management module that generates relationships of the user across a plurality of the content modules through a unified view in which each relationship is independent of the persona currently activated and which is common across past, current, and future content modules.

19. The method of claim 18 further comprising providing a feedback rating through intelligence gathered from personal representation of the user to other users, perception of other users, behavior analysis of the user and linked other users through a relationship behavior compounding algorithm, and collective contact rating of peers.

20. The method claim 18 in a form of a machine-readable medium embodying a set of instructions that, when executed by a machine, causes the machine to perform the method of claim 18.
